(19) United States
(12) Patent Application Publication
(10) Pub. No.: US 2003/0226796 A1
(43) Pub. Date: Dec. 11, 2003

(54) Modular system for separating components of a liquid sample

(75) Inventors: Glen H. Bayer JR., Cottage Grove, MN (US); Jason R. Jacobson, Columbia, MO (US); Craig A. Perman, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/167,219

(22) Filed: Jun. 11, 2002

(51) Int. Cl. B01D 36/02

(52) U.S. Cl. 210/259; 210/262; 210/511; 210/323.1; 422/101

(57) ABSTRACT

The present invention provides a modular system for separating components of a liquid sample. The system includes arrays of units that may be assembled in series to perform multiple separations on a liquid sample in a single step. Also, the modular nature of the system permits a device according to the present invention to be designed to perform different separation schemes on one or more liquid samples within a single device.

### BACKGROUND OF THE INVENTION

Chemical and analytical processes often require separating components of a liquid sample. For example, a liquid sample may include solutes or suspended particulates that inhibit or otherwise interfere with certain chemical or analytical processes. Therefore, it may be desirable to remove one or more potentially interfering components from the liquid sample before subjecting the sample to a chemical or analytical process. This may be particularly desirable when the liquid sample has a biological source and, therefore, may include a large number of potentially interfering substances.

Many methods of separating components of a liquid sample are known, e.g., filtration, affinity chromatography, ion exchange chromatography, size exclusion, solid phase extraction, microfiltration, and the like. Many of these separation methods have been incorporated into devices that permit separation of multiple samples at once. Such devices often conform to a standardized format such as a 96-well or 384-well array.

For example, a multi-well test plate may include a plurality of test strips in which each test strip includes a number of wells. The wells may include a microporous membrane for separating a liquid sample. The separation may be performed by spinning the multi-well test plate in a centrifuge.

Microliter quantities of liquid sample may be separated using a multi-well plate that includes a linear array of filter wells releasably attached to a base. Each well in an array forms a cylinder. One end of the cylinder is open for receiving the liquid sample. The other end of the well includes filter material that is attached to the bottom surface of the cylindrical wall of the well. The filter material may be attached by heat sealing, ultrasonic welding or otherwise adhering to the bottom surface of the cylinder. The filter array/base assembly may be connected to a vacuum manifold that provides a pressure differential that draws a liquid sample in a well through the filter material, thereby performing some degree of separation on the sample.

Another device provides a plurality of sample containers, each of which may include a layer of selectively absorbing separation material secured inside the sample container with a retaining ring. Securing the separation material inside the sample container in this manner reduces the likelihood and extent to which the liquid sample can leak past the separation material. It also reduces the likelihood that the separation material may become dislodged from the well because the separation material is physically anchored inside the sample container portion of the well and is not merely adhered to the bottom edge of a cylindrical well wall. The device may be connected to a vacuum manifold in order to draw the liquid samples through the separation material, thereby achieving separation of the samples.

Certain devices permit column chromatography to be performed simultaneously on a plurality of liquid samples. A collection plate containing a plurality of collection wells is connected to a column manifold containing a plurality of apertures. The collection wells and apertures are aligned to conform to a standardized format. Each aperture in the column manifold is capable of receiving a separation column containing a liquid sample. Column chromatography may be performed on the liquid sample using centrifugation or a vacuum.

A solid phase extraction (SPE) assembly may include a plurality of collection wells arranged to conform to a standardized format such as a 96-well array. The assembly also may include a plurality of removable extraction cartridges aligned with the collection wells. Each cartridge may include an outlet spout to assist in directing the liquid sample from the extraction cartridge into a corresponding collection well. Each cartridge also may include a frit/sorbent composite pressed against the inside wall of the cartridge. In some cases, the frit-sorbent composite may be supported by a support structure designed to prevent the frit/sorbent composite from sagging into the outlet spout as liquid sample passes through he cartridge.

Certain filtration systems include a vacuum manifold base and a removable cover containing apertures capable of receiving columns having filter material for filtering a liquid sample. The inside walls of each column are tapered so that the diameter of the open portion of the column is greater at the top of the column than at the bottom of the column. The filter material is press fit in the column to a point where the filter material rests on a ledge formed in an interior wall of the column. If desired, a larger diameter filter may be employed and seated against a second ledge formed in an interior wall of the column. The columns may be integrally formed to provide a set of columns arranged in an array.

### SUMMARY OF THE INVENTION

The present invention provides a modular separation device for separating a liquid in which the device includes a first array of separation units and a second array of units. Each unit in the first array of units includes at least one body wall that defines an inlet end and an outlet end, and also includes at least one mating structure configured to be complementary to a mating structure of a corresponding unit of a second array; an inlet opening at the inlet end; a separation layer disposed between the inlet opening and the outlet end; and at least one placement structure associated with the at least one body wall or the separation layer. Each unit in the second array of units includes at least one body wall that defines an inlet end and an outlet end and at least one mating structure configured to be complementary to the mating structure of a corresponding separation unit. Furthermore, at least one unit of the second array includes a separation layer disposed between the inlet end and the outlet end of the unit.

Certain embodiments include a third array of units. Each unit in the third array includes a body having an inlet end and an outlet end and at least one body wall that defines, at least in part, an inlet opening at the inlet end and an outlet opening at the outlet end; and at least one mating structure at the outlet end configured to be complementary to the mating structure at the inlet end of the at least one unit of the second array.

In certain embodiments, a separation layer, when present may be secured using a securing member such as a retaining ring.

In another aspect, the present invention provides a modular element of a device for separating a liquid sample in which each modular element includes a plurality of separation units. Each separation unit includes a body having an inlet end, an outlet end, and at least one body wall that at least partially defines an inlet opening at the inlet end and an outlet opening at the outlet end; at least one mating structure generally located at the inlet end of the body and configured to mate with a complementary mating structure of a stackable element, thereby forming a mating junction; and a separation layer disposed between the inlet opening and the outlet opening.

In certain embodiments, each unit also may include a second mating structure generally located at the outlet end of the body configured to mate with a complementary mating structure of a second stackable element.

The separation layer, when present, may include a filter, a solid phase extraction (SPE) medium, a porous thermoplastic or metallic frit, a microporous membrane, a nonwoven glass fiber matrix, a packed particle column, or any combination of the above. The modular element also may include one or more units that do not include a separation layer.

Various other features and advantages of the present invention should become readily apparent with reference to the following detailed description, examples, claims and appended drawings. In several places throughout the specification, guidance is provided through lists of examples. In each instance, the recited list serves only as a representative group and should not be interpreted as an exclusive list.

### BRIEF DESCRIPTION OF THE DRAWINGS

In the several figures of the attached drawing, like parts bear like reference numerals, and:

FIG. 1 is an expanded perspective view of one embodiment of a separation device according to the present invention.

FIG. 2 is a side cross-section view of a portion an array of tip units according to one embodiment of the present invention.

FIG. 3 is a side cross-section view of an alternative embodiment of a tip unit according to the present invention.

FIG. 4 is a side cross-section view of a portion of an array of intermediate units according to one embodiment of the present invention.

FIGS. 5a-d are side cross-section views of exemplary embodiments of mating structures according to the present invention.

FIGS. 6a and 6b are side cross-section views of exemplary embodiments of placement structures according to the present invention.

FIG. 7a is a top view of one embodiment of a separation layer according to the present invention.

FIG. 7b is a side cross-section view of the separation layer shown in FIG. 7a.

### DETAILED DESCRIPTION OF ILLUSTRATIVE EMBODIMENTS OF THE INVENTION

Many chemical or analytical processes involve separating one or more components of a liquid sample. Often, only a limited amount (i.e., microliter volumes) of a liquid sample may be available. For example, sample preparation for genomic or proteomic applications can require separation of a microliter-volume liquid sample in order to obtain a sample that is useful for a particular process or analysis. Alternatively, one may wish to perform one or more diagnostic analyses on microliter-volume samples that are not readily replaceable or replenishable. Because biological samples often have include a large number of substances that can interfere with the sensitivity or specificity of a particular process or analytical assay, it may be desirable to be able to perform multiple separations on biological samples. The present invention provides devices and methods for subjecting a liquid sample to multiple separations. The present invention also provides devices and methods for performing separations on a plurality of liquid samples. The devices may be designed so that all samples loaded into a device are treated similarly, i.e., undergo the same separation regimen. Alternatively, the device may be configured so that the user controls the particular separation scheme to which a sample is subjected. Thus, a plurality of samples may be subjected to any number—up to the number of samples being loaded into the device—of different separation schemes.

Certain devices according to the present invention offer many advantages over presently known separation devices. Separation devices according to the present invention include modular components that permit the user to conveniently design the separation scheme for each sample. In some cases, each sample may be subjected to the same separation scheme while in other cases it may be desirable to design different separation schemes for different samples.

Each modular component may be small enough to (a) minimize loss of sample, for example, between separations, and (b) provide certain manufacturing advantages. The modular components may be stackable so that a plurality of components may be connected in series. Each component may or may not include a separation layer, as desired. In this way, one can design a device including a plurality of modular components suitable for subjecting multiple samples to a plurality of separation schemes, each scheme capable of having multiple separation steps. Having all of the several separations performed within a single device saves substantial labor associated with transferring partially processed samples from one separation device to another device for a subsequent separation step.

Therefore, the devices of the present invention are particularly suited for performing high throughput processes including but not limited to sample preparation and high throughput analyses including but not limited to diagnostic assays, each of which may involve liquid samples from multiple sources, multiple separation schemes, separation schemes including multiple separation steps, or any combination of the foregoing.

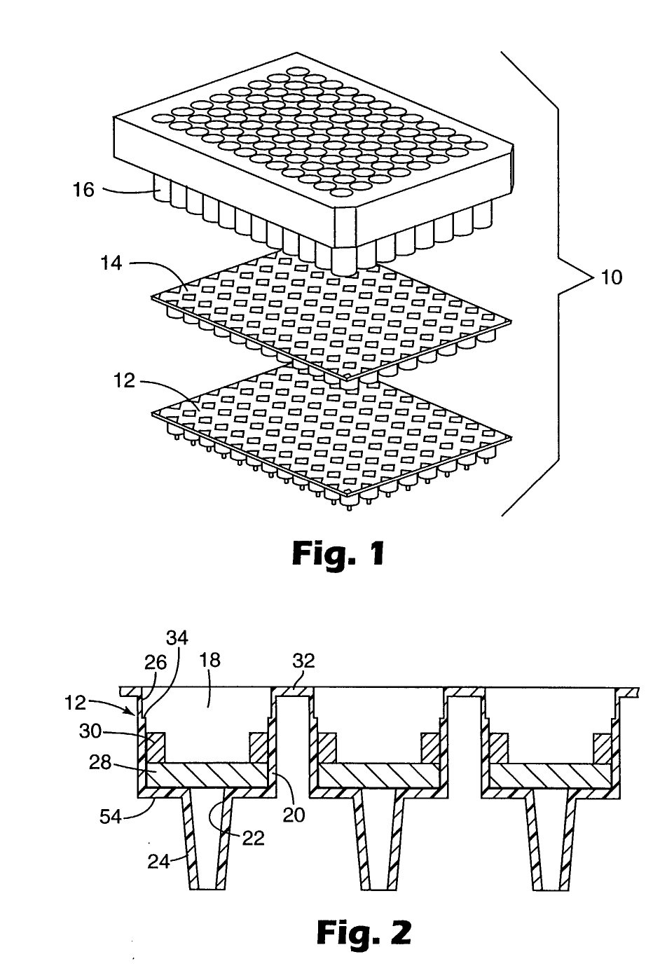

FIG. 1 shows an exploded view of one embodiment of a modular separation device 10 according to the present invention. The embodiment shown includes an array of tip units 12, an array of intermediate units 14, and an array of sample containers 16. When the device is assembled, the tip units, intermediate units, and sample containers may be aligned to form an array of separation chambers. Thus, each separation chamber of the device illustrated in FIG. 1 includes, in series, a tip unit, an intermediate unit, and a sample container. Generally, the number and types of units in the arrays that are assembled to form a separation device determine the composition of a separation chamber.

The device shown in FIG. 1, when assembled, includes an array of 96 separation chambers that conforms to a standard 96-well format. That is, the separation chambers are configured to receive samples from, for example, a standard 96-tip pipettor and deposit separated samples into, for example, a 96-well microtiter plate.

Devices that conform to a standard format (e.g., 96-well) may provide the advantage of being suitable for use with existing instrumentation. However, devices according to the present invention may be designed to conform to any format. For example, a device may be designed to include separation chambers in any two-dimensional array (e.g., 8×12, 16×24, etc.), any length of linear array, or an irregular- or non-array format. For convenience only, the following description of devices according to the present invention is provided in terms of a two-dimensional array. The modular features of the present invention are equally applicable to linear array and irregular- or non-array devices.

The array of tip units 12, array of intermediate units 14, and array of sample containers 16 each may be manufactured as frangibly connected units in a bulk array. Therefore, each array of units that is to be incorporated into a separation device 10 may be provided by (1) separating the desired array of units from the bulk array, or (2) assembling a plurality of smaller arrays. Moreover, one array may be provided in one manner (e.g., separation from a bulk array) while one or more of the other arrays may be provided in a different manner (e.g., assembly of smaller arrays).

This feature of the present invention provides a user with the flexibility to design a separation device according to the present invention to best satisfy the user's specific needs for a particular application. Also, any number of separation chambers within an array may be used for a particular application. As will be discussed in more detail below, certain portions of the array may be designated for different separation schemes or may be left unused.

Tip Units

As used herein, a tip unit refers to the unit at the outlet end of a separation chamber. Thus, a tip unit may form only one mating junction, that mating junction being at the inlet end of the tip unit. In many applications, liquid sample that has been subjected to one or more separations in the separation chamber exits the separation chamber through the outlet opening of a tip unit for collection, analysis, detection, further processing, etc.

FIG. 2 illustrates a portion of a linear array of tip units 12. Adjacent units in the array are connected by a frangible connection 32. Each unit includes a body wall 20. In the embodiment shown, the body wall 20 is continuous with the connection 32. However, the connection 32 may include any means of frangibly connecting adjacent units. Each tip unit includes an inlet opening 18 and an outlet opening 22.

Tip units may be constructed of any suitable material. Suitable materials include materials that provide sufficient structural integrity for a particular application. In some embodiments, materials used for construction of the tip units may be selected to be inert with respect to suspected components (e.g., solvents, solutes, suspended particulates, and the like) of liquid samples that may be separated in a device that includes the tip units. Suitable materials include but are not limited to glass, metals, and thermoplastic polymers such as polystyrenes, polypropylenes, polyurethanes, polyethylenes (including high-density polyethylene), polycarbonates, polyacrylates, polymethacrylates, polyvinyl chlorides, and the like.

Each tip unit also includes at least one mating structure 34 designed to be complementary to a mating structure of a corresponding stackable element. When assembled, the mating structures of the tip unit and the stackable element form a mating junction. The stackable element may be either an intermediate unit or a sample container, depending upon the design of the separation device 10. The mating structures may be of any suitable design and may result in either a reversible or permanent connection (i.e., mating junction) between the tip unit and the stackable element. Also, regardless of whether the mating structures form a reversible or permanent connection, the mating structures may form a hermetic seal at the mating junction.

FIG. 2 shows an array of tip units in which each tip unit includes a mating structure 34 that includes a recess (i.e., a female mating structure) in the form of a shelf near the inlet end opening 18. The illustrated mating structure 34 is designed to receive a complementary mating structure (i.e., a male mating structure) of a corresponding stackable element, e.g., an intermediate unit. However, the tip unit may include a male mating structure and the corresponding stackable element may include the complementary female mating structure.

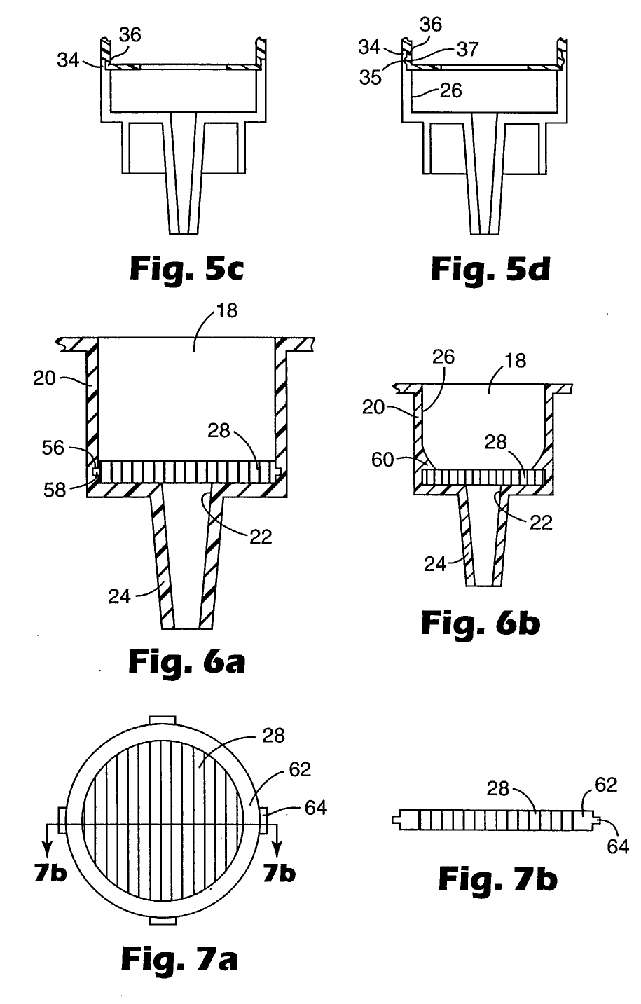

A female mating structure may include any specialized structure intended to receive a complementary structure male mating structure. Such specialized female mating structures include but are not limited to a recess, groove, shelf, and the like. However, a female mating structure may be as simple as a body wall configured to have an internal diameter that is slightly greater than the external diameter of a male mating structure of another stackable element, as shown, for example, in FIG. 5b. Thus, a mating junction resulting from the assembly of units having such mating structures may create a slight interference fit connection.

FIG. 5d illustrates an alternative embodiment in which the tip unit mating structure 34 includes a recess 35 in the interior surface of the body wall 26. The intermediate unit mating structure 36 includes a protrusion 37 designed to fit within the recess 35 and thereby form a snap-fit connection. Alternatively, the snap-fit connection may be provided by a recess on the intermediate unit and a complementary protrusion on the tip unit.

In some embodiments, a male mating structure may have an outward bias so that it exerts face pressure against the interior surface of the female mating structure. In this way, the mating structures may create a press-fit connection.

Each tip unit may include one or more separation layers 28. The separation layer 28 may be constructed from any material suitable for separating one or more components of a liquid sample. Materials suitable for use in constructing the separation layer 28 include but are not limited to a filter, a solid phase extraction (SPE) medium, a porous thermoplastic or metallic frit, a microporous membrane, a nonwoven glass fiber matrix, a packed particle column, and the like. The separation layer may achieve separation of the liquid sample by one or more separation strategies, including but not limited to size exclusion, affinity, ion exchange, solid phase extraction, ligand binding, chelation, microfiltration, and the like. The particular separation layer material used may be at least in part determined by the particular component that is intended to be separated from the liquid sample. For example, a particle derivatized with a non-polar hydrocarbon (e.g., a C18 hydrocarbon) may be particularly desirable for separating one or more non-polar components from a liquid sample. Many separation materials are known to those of ordinary skill in the art and separation strategies employing the known separation materials are also known.

In certain embodiments, the separation layer includes a three-layer laminate that includes a sheet of SPE medium between a pre-filter layer and a support layer. Suitable laminates are described in International Publication No. WO 00/15331, published Mar. 23, 2000, and International Publication No. WO 01/51206, published Jul. 19, 2001.

The separation layer also may include a scrim layer for structural support. Certain separation materials may not be sufficiently robust, alone, to withstand the combination of forces (e.g., positive pressure or vacuum potential) to which the separation layer is exposed during use of the device. Nevertheless, those materials may have particularly desirable separation characteristics for a particular separation scheme. Thus, a scrim may be included in the separation to provide additional structural support for the separation material. In this way, a broader scope of suitable separation materials may be used in a device according to the present invention, allowing such devices to have broader utility. Any suitable supportive material may be used to construct the scrim layer. The scrim material may be selected so that it is substantially inert to the components of the liquid sample. Alternatively, the scrim material itself may provide some degree of sample separation.

The separation layer 28, when present, may be secured within a tip unit by any suitable means. Suitable means include structures or features that may be included in or on the body wall 20, structures or features that may be included in or on the separation layer 28, a securing member, or any combination of any of the foregoing.

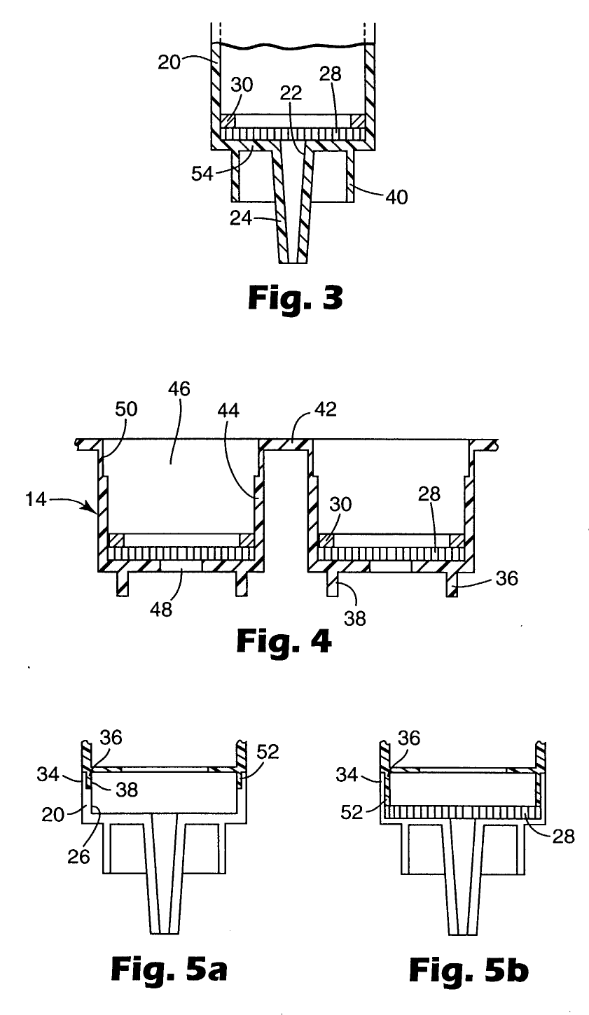

Suitable body wall structures include but are not limited to a ledge, a recess, or a tab. A ledge may include any structure that extends generally perpendicular to the interior surface of the body wall 20 and can provide positional support to the separation layer 28. For example, a bottom wall 54 portion of the body wall, shown in FIGS. 2 and 3, may be considered to be a ledge providing positional support to the separation layer 28. A ledge may be an integral structure of the body wall or a non-integral structure affixed to the body wall in any suitable manner.

A recess 56, shown in FIG. 6a, may include any form of slot, indentation, invagination or the like into which an insertable portion 58 of the separation layer 28 may be inserted, thereby providing positional support for the separation layer 28. A tab 60, shown in FIG. 6b, may include any structure of the interior surface of the body wall 26 that generally constricts the diameter of the tip unit and then forms an inverted ledge. Thus, the separation layer 28 may be inserted into the tip unit past the tab 60 and snap-fitted in place.

Suitable body wall features that may help secure the separation layer include an adhesive area. The adhesive area may be inherently adhesive as a result of materials selected to construct the body wall 20. Alternatively, an adhesive may be applied to a portion of the body wall 20 for securing the separation layer 28. Suitable adhesives include but are not limited to pressure sensitive adhesives, thermoset adhesives, hot-melt adhesives, film adhesives, activated adhesives, and the like.

Suitable separation layer structures include but are not limited to a frame, a scrim, an outwardly biased tensile member, and the like.

A frame 62, such as that shown in FIG. 7a, may include any external element providing structural support to the separation layer. A frame may be a continuation of the separation layer material or, alternatively, may be constructed of a different material than the separation layer. If it is constructed of a different material than the separation layer, at least a portion of the frame may be attached to at least a portion of the separation layer.

A frame may provide positional support for the separation layer in conjunction with a ledge or recess in the body wall of the tip unit. In combination with a ledge, a portion of the frame may rest on a portion of the ledge. The frame may be designed to provide a fluid-tight press fit with the body wall, thereby securing the position of the frame and, therefore, the separation layer 28. Alternatively, an adhesive may be used to secure the position of the separation layer. The adhesive may be applied to a portion of the ledge, a portion of the frame, or both. An adhesive may be used alone or in combination with a frame designed to provide a fluid-tight press fit.

In combination with a recess in the body wall, a portion of the frame may fit within the recess. In some embodiments, the recess may form a continuous recessed channel in the body wall and the edge of the frame may be configured to fit into the channel. In other embodiments, the body wall may include a plurality of recesses and the frame may include a plurality of structures such as flanges 64, shown in FIG. 7b. The flanges 64 may be designed to fit into recesses in the body wall, thereby providing positional support for the separation layer. An adhesive may be applied to a portion of a recess, a portion of the frame, or both in order to further secure the frame and, therefore, the separation layer.

In certain embodiments, the separation layer may be secured by incorporation of an outwardly biased tensile member at or near the periphery of the separation layer. The tensile member may be designed to conform to the shape of the interior surface of the body wall—either by being constructed to the specified shape or by being sufficiently malleable that it is able to adopt the conformation imposed by the interior surface of the body wall. The tensile member also may serve to stretch the separation layer, thereby promoting complete and efficient flow of the liquid sample through the separation layer, thereby also promoting complete and efficient separation of the liquid sample.

The separation layer also may be secured, at least in part, by certain features of the separation layer. For example, as previously described, the separation layer may include one or more adhesive areas. The adhesive area may result from the application of an adhesive or may be inherent from the materials used to construct the separation layer.

In some embodiments, a securing member may secure the separation layer inside the tip unit. In one embodiment, the securing member may include a retaining ring 30. For example, the separation layer 28 may be secured with a retaining ring 30 that forms a substantially fluid-tight face seal with the body wall 20 of the tip unit and a substantially fluid-tight compressive seal with the separation layer 28. Thus, a retaining ring 30 promotes more complete treatment of a liquid sample by the separation layer 28 because the retaining ring 30 limits the likelihood and extent to which a portion of the liquid sample may leak around the separation layer 28.

Certain embodiments of the present invention include features that provide manufacturing advantages, particularly when present in conjunction with the use of a retaining ring to secure the separation layer. For example, the distance between the inlet opening 16 and the final location of the retaining ring 30 may be relatively short in the tip units of the present invention. A relatively short distance may ease placement of a retaining ring in the tip unit. If the placement of the retaining ring is performed manually during manufacture of the tip unit array, increasing the ease with which one can properly place the retaining ring in the tip unit may provide substantial reduction in labor production costs.

The separation layer may be secured using any one or combination of structures, features or additional members described above. Some structures or features, alone, may provide a fluid-tight seal. For example, the retaining ring may be designed, and certain adhesives may be selected, to provide a fluid-tight seal.

In other cases the securing member may not, by itself, limit the likelihood and extent to which a portion of the liquid sample might leak around the separation layer. Thus, in embodiments in which the securing member does not, by itself, provide a fluid-tight seal, it may be desirable that the tip unit also includes means for limiting the likelihood and extent of sample leakage. For example, a gasket may be used in conjunction with the securing means. The gasket may be provided as a separate element of the tip unit. Alternatively, a portion of the securing means may be designed to have gasket-like properties, i.e., capable of forming a fluid-tight seal. For example, a supportive frame or a tensile member may include a gasket-like edge that is able to form a fluid-tight seal with the body wall.

Each tip may further include a spout 24 to help direct liquid sample from the tip unit to a collection chamber. Each unit also may further include a collar 40. The collar 40 may be configured to fit inside an internal wall of a collection chamber and, therefore, assist in aligning the tip unit (and, by extension, the separation chamber) with the collection chamber (e.g., a well of a 96-well microtiter plate).

Intermediate Units

As used herein, an intermediate unit refers to any unit that is not a tip unit or a sample container. A tip unit may be designed similarly to a tip unit except that an intermediate unit may be capable of forming a mating junction at its outlet end. A tip unit may be designed similarly to a sample container except that an intermediate unit may be capable of forming a mating junction at its inlet end. Indeed, an intermediate unit may function as a sample container if the intermediate unit is able to hold the entire volume of liquid sample.

One embodiment of an array of intermediate units 14 according to the present invention is shown in FIG. 4. The array may be linear (as shown) or two-dimensional. Individual intermediate units may be connected in the array by a frangible connector 42. Thus, one or more intermediate units may be separated from an array for use in a separation device such as that shown in FIG. 1.

Each intermediate unit includes a body wall 44 that defines, at least in part, an inlet opening 46 and an outlet opening 48. At the outlet end, each intermediate unit includes a first mating structure 36 designed to be complementary to a mating structure of a corresponding first stackable element. Depending upon the configuration of the separation device, the first stackable element may include, for example, another intermediate unit or a tip unit. Each intermediate unit also includes a second mating structure 50 designed to be complementary to a mating structure of a corresponding second stackable element. Depending upon the configuration of the separation device, the second stackable element may include, for example, another intermediate unit or a sample container.

The embodiment shown in FIG. 4 illustrates an array of intermediate units in which the first mating structure includes a male mating structure and the second mating structure includes a female mating structure. However, each mating junction may be designed in any suitable manner, i.e., in any mating pair the top stackable element may include either a male or female mating structure and the bottom stackable element also may include either a male or female mating structure, so long as the mating structures are complementary to one another so that the stackable elements can properly mate.

FIGS. 5a-d illustrate some possible mating structure embodiments. FIGS. 5a-d illustrate mating junctions between a tip unit and a intermediate unit. However, the mating structures shown may be included in any mating junction between two stackable units in a separation device according to the present invention, e.g., an intermediate unit-intermediate unit mating junction or a sample chamber-intermediate unit mating junction.

For clarity, FIGS. 5a-d generally show units without a separation layer and securing member, except for the tip unit of FIG. 5b, which includes a separation layer. A separation layer and, when appropriate, a securing member may be used in conjunction with any of the mating structures illustrated in FIGS. 5a-d, as well as many mating structures not specifically illustrated.

FIG. 5a shows a mating junction between a tip unit and an intermediate unit. As illustrated, the tip unit includes a mating structure 34 that includes a shelf in the body wall 20. The shelf forms a female mating structure that can receive a male-type intermediate unit mating structure 36. The intermediate unit mating structure 36 may include a stake 52 that may at least partially secure the mating junction. In certain embodiments, such as that shown in FIG. 5a, the interior surface of the stake 38 may be substantially flush with the interior surface of the body wall 26. Such an embodiment may decrease the likelihood and extent of sample loss due to irregularities in the body wall at the mating junction.

An alternative approach to minimizing sample loss is shown in FIG. 5c. The female mating structure includes a shelf in the body wall, while the male mating structure includes a notch that fits into the shelf of the female mating structure. In contrast to the embodiment shown in FIG. 5a, the male mating structure shown in FIG. 5c does not include a stake. A mating junction such as that shown in FIG. 5c may provide a readily reversible mating junction, which may be desirable for certain applications.

FIG. 5b illustrates an alternative embodiment in which the male-type intermediate unit mating structure 36 includes a stake 52 that extends far enough into the tip unit so that the stake 52 contacts the separation layer 28 of the tip unit. This design may eliminate the need for a separate securing member to secure the separation layer 28 because the stake 52 may provide a mating function and simultaneously may secure the separation layer of the tip unit. The end of the stake 52 may include a gasket or gasket-like material so that the junction of the stake 52 and the separation layer 26 forms a substantially fluid-tight seal.

FIG. 5d illustrates a snap-fit mating junction. As shown, the male-type intermediate unit mating structure 36 includes a protuberance that is complementary to a recess formed in the female-type tip unit mating structure 34. Alternatively, a female mating structure may include the protuberance and the complementary male mating structure may include the recess. A protuberance may be of any suitable geometry including but not limited to a nub, a bump, a ridge, a spike, a cone, and the like. A mating junction may include one or more protuberance-recess pairs. If a plurality of protuberance-recess pairs is present, the plurality may include any desired heterogeneous or homogeneous combination of geometries. The snap-fit character of the mating junction shown in FIG. 5d may provide greater integrity to the mating junction because the mated units may be less readily separable.

Referring again to FIG. 3, each intermediate unit also may include one or more separation layers 28. Suitable materials for use in the separation layer of an intermediate unit include those materials listed above with regard to the materials suitable for use in the separation layer of a tip unit. The separation layer 28, if present, may be secured in any manner described above as suitable for securing the separation layer of a tip unit.

Intermediate units may be constructed from any suitable material. Suitable materials include those materials suitable for construction of the tip units. The intermediate units may be constructed from the same materials as those used to construct the tip units in certain embodiments. If desired, however, the intermediate units may be constructed of different materials than those used to construct the tip units.

If desired, the intermediate units may include a collar, spout, or both, as shown with regard to a tip unit in FIG. 3, but such structures are not required.

Sample Containers

As used herein, a sample container refers to a unit that optionally may be included at the inlet end of a separation chamber. Thus, a sample container may form only one mating junction, that mating junction being at the outlet end of the sample container.

Devices according to the present invention also may include one or more sample containers. A sample container generally includes a hollow enclosure designed to connect to a tip unit or an intermediate unit. Thus, a sample container generally adds volume capacity to a separation chamber. If a plurality of sample containers is present, the sample containers may be arranged in any form or size of array, as previously described with regard to tip units and intermediate units. A sample container optionally may include one or more separation layers. If desired, any separation layer in a sample container may be secured with a securing member. Materials and designs suitable for the separation layer and securing member in a sample container include those materials and designs described above as suitable for the separation layer and securing members of the tip units and intermediate units.

Each sample container includes at least one body wall that at least partially defines an inlet opening at an inlet end and an outlet opening at the outlet end. Suitable structures and materials for the body wall and, if present, separation layer and securing member of a sample container include those structures and materials previously described with regard to the structures and materials suitable for the body wall, separation layer and securing member, respectively, of the tip units and intermediate units.

A liquid sample may be loaded into a separation chamber through the inlet opening of the sample container. At the outlet end, the sample container includes a mating structure that is designed to be complementary to a mating structure of a corresponding stackable element. Depending upon the design of the separation device, the stackable element may be a tip unit or an intermediate unit. The sample container mating structure may include any suitable mating structure including but not limited to those previously described as suitable for tip units and intermediate units.

Separation Devices

A separation device according to the present invention includes an array of separation chambers. Each separation chamber may include a plurality of units in series. Each unit may be a member of an array, such as is shown with regard to tip units in FIG. 2. Thus, a separation device according to the present invention may include a plurality of stacked arrays, as shown in FIG. 1. Each array, and therefore the separation device, may be a linear array or a two-dimensional array.

A unit of a first array (e.g., a tip unit) may include a mating structure that is complementary to a mating structure of a corresponding unit of a second array (e.g., a intermediate unit), so that the two units can be assembled to form a mating junction. Either unit may include a female mating structure so long as the other unit includes a male mating structure so that the two can properly mate.

A unit may include more than one mating structure. For example, a unit may be designed to mate with two other units to form a series of three units. If a unit includes more than one mating structure, it may include any suitable combination of male and female mating structures. For example, a unit having two mating structures may include two female mating structures, two male mating structures, or one female mating structure and one male mating structure.

The particular mating structures used at one mating junction between two units may be the same or different than the mating structures used to form any other mating junction, whether in the same separation chamber or a different separation chamber. For example, a separation device according to the present invention may include a two-dimensional array of separation chambers, each chamber including three units: a tip unit, a intermediate unit and a sample container. A plurality of chambers may include one or more snap-fit connections in order to provide a generally secure assembly. Other chambers in the array may include slight interference fit or press-fit connections.

Similarly, a separation chamber that includes a plurality of units also may include a plurality of separation layers. A plurality of separation layers may be provided one separation layer per unit, two or more separation layers per unit, or any combination of units having different quantities of separation layers.

The material used to construct one separation layer and, therefore, the component of the liquid sample intended to be separated by that separation layer, may be the same or different than any other separation layer in the separation chamber. Also, the separation layers and particular combination of separation layers used in one separation chamber may be the same or different than the separation layers or combination of separation layers used in any other separation chamber. Thus, a single separation device that includes a plurality of separation chambers may be designed to perform a variety of different separation schemes.

A single separation chamber in a device according to the present invention may include a plurality of units. Each unit may have a separation layer and a securing member. The separation layer of one unit (e.g., a intermediate unit) may be the same or different than the separation layer of any other unit (e.g., a tip unit, intermediate unit or sample container) in the separation chamber. Also, the securing member used to secure a separation layer in one unit may be the same or different than the securing member used to secure the separation layer of any other unit.

The variety of separation schemes possible using a device according to the present invention is at least partially due to the modular nature of the device. A device may be custom designed to perform as many or as few separation schemes as desired. Moreover, each separation scheme may be as simple (a single separation performed on a plurality of identical samples) or as complex (multiple separations performed on multiple samples) as desired.

A device according to the present invention may be designed to perform single separations such as those familiar to one skilled in the art. Thus, one is able to perform a full range of separations using devices according to the present invention. It may be particularly convenient to one skilled in the art to be able to perform simple and complex separation schemes using a single system.

A simple separation scheme may be performed by providing a separation layer in each tip unit in an array. The dimensions of the array may be custom designed for a particular application. For example, if one has ten liquid samples that require filtration, one can design an array including ten separation chambers, each separation chamber including at least a tip unit.

As previously described, the tip units may be constructed and provided in a bulk array of frangibly connected units. The bulk array may be a linear array of any convenient length or a two-dimensional array of any convenient size. Tip units may be removed from the bulk array and transferred for use a separation device. Filtration material may be loaded into the tip units and secured, if desired, with an appropriate securing member during construction, after the tip units are removed from the bulk array, or after the tip units are assembled into the separation device.

If the volume of any sample is greater than the volume of the tip unit, a sample container may be connected to as many tip units as necessary to permit the array to hold all of the liquid samples. In general, the sample container may or may not include a separation layer. Because a separation layer is present in the tip unit in this example, a separation layer is not required in the sample container.

The liquid samples may be loaded into the separation chambers. The liquid samples may be drawn through the filtration material by any suitable method including but not limited to gravity, centrifugation, applying positive pressure, or applying a negative pressure differential, such as may be provided by a vacuum manifold. Use of a vacuum manifold may include the use of a base configured to conform to a standardized array format. If only a portion of the standardized array format is used, as in the present example, some means of providing a substantially airtight seal over the unused portion of the array may be desirable to maintain a sufficient pressure differential to draw the liquid samples through the filtration medium. The filtered samples may be collected in any suitable collection chambers including but not limited to standardized multi-well arrays.

A simple two-dimensional array may be used to separate many aliquots of a larger liquid sample. For example, a full 96-chamber array may be used to separate 96 aliquots of a liquid sample. In one embodiment, each separation chamber may be designed to have a separation layer constructed from the same separation material as the separation layers of every other separation chamber.

Alternatively, sub-arrays within the separation device may be dedicated to performing different separations on aliquots of a single large sample. For example, a device according to the present invention may be constructed to include three different 9×4 arrays of separation chambers within a larger 96-chamber array. Each 9×4 array may be differentiated from the other 9×4 arrays by the material selected for use in the separation layer and, therefore, the component or components of the liquid sample intended to be removed from the sample by the 9×4 array.

Each sub-array may be formed by removing a 9×4 array from a bulk array including the desired separation layer pre-loaded into the units of the bulk array. Alternatively, a sub-array may be formed by assembling any sub-combination of arrays (linear, two-dimensional, or both) of appropriate units to achieve the desired sub-array dimensions (in this case, 9×4). In yet another alternative, the sub-array may be formed by loading the desired separation material into appropriate units of a larger array.

Aliquots of the liquid sample may be loaded into all of the separation chambers. The aliquots may be drawn through the separation chambers and collected by any suitable methods such as those previously described. In this way, one may perform three different separations on a single liquid sample.

Although described in the context of providing three 9×4 sub-arrays within a 96-chamber device, the separation device and method just described may be designed to particular specifications desirable for a specific application. The sub-arrays need not all be of similar size or dimensions compared to other sub-arrays. The larger array may be of any size and may or may not conform to a standardized array format, although conforming to standardized array formats may be convenient for certain ancillary steps such as loading aliquots of the liquid samples and collecting the separated samples.

A separation device that includes sub-arrays may be useful for performing different separations on a plurality of different liquid samples. In a device that includes three 9×4 sub-arrays as described above, each sub-array may be used to perform separations on a plurality of different liquid samples.

A device according to the present invention may be designed to permit increasingly complex separation schemes by including one or more arrays of intermediate units. Each intermediate unit array may be constructed in a manner similar to that described above for constructing a tip unit array. That is, an intermediate unit array may be linear or two-dimensional and of any size appropriate for the desired separation device. The intermediate units may be constructed and provided in a bulk array of frangibly connected units. Each intermediate unit may include a separation layer that, when present, may be loaded into the intermediate unit during construction, after construction but before assembly into the separation device, or after assembly into the device.

Each intermediate unit array may include sub-arrays that are distinguishable from one another by the separation material used for the separation layers of units within the sub-arrays. Alternatively, certain intermediate units may lack separation layers altogether. Intermediate units lacking separation layers may form a discrete sub-array or may be single units such as, for example, for forming part of a control separation chamber.

When present, the separation layer in a intermediate unit may be constructed of material that is the same or different than the material used to construct the separation layer of any other unit in the same separation chamber. A series of units having similar separation materials in separation layers may be desirable for ensuring that a particular component of a liquid sample is removed from the sample as completely as possible limited as little as possible by factors that can limit the amount of a component that can be removed by a single separation layer, e.g., saturation of the separation material.

A series of units having separation layers constructed of different materials may be desirable for removing, in a single separation step, multiple components from a liquid sample that cannot all be adequately removed from the sample using a single separation material. Any desired combination of separation materials may be stacked in series by incorporation into units assembled into a separation chamber in a device according to the present invention. For example, a separation chamber could be designed to include a first separation layer (e.g., in a sample container) selected for removing large components such as cell debris by size exclusion; a second separation layer (e.g., in a intermediate unit) may be selected to remove nucleic acids; a third separation layer (e.g., in another intermediate unit or a tip unit) may be selected to remove hydrophobic proteins; and so on. In this way, simple or complex separation schemes may be designed for each separation chamber within a device according to the present invention.

Because each array and the units that make up each array are modular, a device according to the present invention may be designed to include separation chambers, side-by-side, that include different separation schemes. Also, because it is not required that each unit include a separation layer, a separation chamber having a complex separation scheme may be side-by-side with a separation chamber having a simple separation scheme simply by providing one or more intermediate units without separation layers in the simple-scheme separation chamber. Intermediate units without separation layer thus may act as spacers that permit all of the separation chambers within the device are of substantially similar height.

Certain embodiments of devices of the present invention having separation chambers of substantially similar height may be desirable for certain applications. For example, such embodiments may permit more accurate loading of liquid samples into the separation chambers, particularly if the loading process is automated. Also, such embodiments may make it easier to create air-tight seals across the entire array of separation chamber inlet openings, such as may be desirable when, for example, the liquid sample is intended to be drawn through the separation layers by the generation of a vacuum.

The complete disclosures of the patents, patent documents and publications cited herein are incorporated by reference in their entirety as if each were individually incorporated. In case of conflict, the present specification, including definitions, shall control.

Various modifications and alterations to this invention will become apparent to those skilled in the art without departing from the scope and spirit of this invention. Illustrative embodiments and examples are provided as examples only and are not intended to limit the scope of the present invention. The scope of the invention is limited only by the claims set forth as follows.

What is claimed is:

1. A modular separation device for separating a liquid comprising:
a first array of separation units, each separation unit of a plurality of separation units comprising:
at least one body wall that defines an inlet end and an outlet end, and comprises at least one mating structure configured to be complementary to a mating structure of a corresponding unit of a second array,
an inlet opening at the inlet end,
a separation layer disposed between the inlet opening and the outlet end, and
at least one placement structure associated with the at least one body wall or the separation layer; and
a second array of units, each unit of a plurality of units of the second array comprising:
at least one body wall that defines an inlet end and an outlet end,
at least one mating structure configured to be complementary to the mating structure of a corresponding separation unit;
wherein at least one unit of the second array further comprises a separation layer disposed between the inlet end and the outlet end of the unit.

2. The modular device of claim 1 wherein the separation layer in at least one separation unit comprises a filter, a solid phase extraction medium, a porous thermoplastic or metallic frit, a microporous membrane, a nonwoven glass fiber matrix, a packed particle column, or any combination of the foregoing.

3. The modular device of claim 2 wherein the separation layer of one separation unit is different than the separation layer of a second separation unit.

4. The modular device of claim 1 wherein the separation layer of at least one unit of the second array comprises a filter, a solid phase extraction medium, a porous thermoplastic or metallic frit, a microporous membrane, a nonwoven glass fiber matrix, a packed particle column, or any combination of the foregoing.

5. The modular device of claim 4 wherein a plurality of units of the second array comprise a separation layer.

6. The modular device of claim 5 wherein the separation layer of one unit of the second array is different than the separation layer of a second unit of the second array.

7. The modular device of claim 3 wherein a plurality of units of the second array comprise a separation layer.

8. The modular device of claim 7 wherein the separation layer of one unit of the second array is different than the separation layer of a second unit of the second array.

9. The modular device of claim 4 wherein the separation layer of at least one separation units is different than the separation layer of at least one unit of the second array.

10. The modular device of claim 1 further comprising a securing member in contact with at least a portion of at least one separation layer.

11. The modular device of claim 10 wherein the securing member comprises a retaining ring.

12. The modular device of claim 1 wherein the second array comprises at least one unit that includes a separation layer and at least one unit that does not include a separation layer.

13. The modular device of claim 1 wherein at least one unit of at least one array comprises two or more separation layers.

14. The modular device of claim 13 wherein the two or more separation layers are constructed from different materials.

15. The modular device of claim 1 wherein the second array comprises at least one unit further comprising at least one mating structure at the inlet end of the unit.

16. The modular device of claim 15 further comprising a third array that comprises a plurality of units, each unit of the third array comprising:
a body having an inlet end and an outlet end and comprising at least one body wall that defines, at least in part, an inlet opening at the inlet end and an outlet opening at the outlet end; and
at least one mating structure at the outlet end configured to be complementary to the mating structure at the inlet end of the at least one unit of the second array.

17. The modular device of claim 16 wherein at least one unit of the third array further comprises a separation layer disposed between the inlet opening and the outlet opening.

18. The modular device of claim 17 wherein the separation layer of the unit of the third array comprises a filter, a solid phase extraction medium, a porous thermoplastic or metallic frit, a microporous membrane, a nonwoven glass fiber matrix, a packed particle column, or any combination of the foregoing.

19. The modular device of claim 18 wherein a plurality of units of the third array comprise a separation layer.

20. The modular device of claim 19 wherein the separation layer of at least one unit of the third array is different that the separation layer of a second unit of the third array.

21. The modular device of claim 20 wherein the separation layer of at least one unit of the third array is different from the separation layer of at least one unit in the first array.

22. The modular device of claim 20 wherein the separation layer of at least one unit of the third array is different from the separation layer of at least one unit in the second array.

23. The modular device of claim 16 wherein at least one unit of at least one array comprises two or more separation layers.

24. The modular device of claim 23 wherein the two or more separation layers are constructed from different materials.

25. A modular element of a device for separating a liquid sample comprising:
a plurality of separation units in which each separation unit comprises
a body having an inlet end and an outlet end, and comprising at least one body wall that at least partially defines an inlet opening at the inlet end and an outlet opening at the outlet end;
at least one mating structure generally located at the inlet end of the body and configured to mate with a complementary mating structure of a stackable element, thereby forming a mating junction; and
a separation layer disposed between the inlet opening and the outlet opening.

26. The modular element of claim 25 wherein the separation layer comprises a filter, a solid phase extraction medium, a porous thermoplastic or metallic frit, a microporous membrane, a nonwoven glass fiber matrix, a packed particle column, or any combination of the foregoing.

27. The modular element of claim 26 wherein the separation layer of a first separation unit is different that the separation layer of at least one other separation unit.

28. The modular device of claim 25 wherein at least one separation unit comprises two or more separation layers.

29. The modular device of claim 28 wherein the two or more separation layers are constructed from different materials.

30. The modular element of claim 25 wherein the mating structure of at least one separation unit and the complementary mating structure of at least one stackable element form a reversible press fit seal.

31. The modular element of claim 25 wherein the mating structure of at least one separation unit and the complementary mating structure of at least one stackable element form an at least substantially irreversible seal.

32. The modular element of claim 25 wherein the separation unit and the stackable element form a snap-fit connection.

33. The modular element of claim 32 wherein the mating structure of one of the separation unit and the stackable element comprises a protuberance and the mating structure of the other unit comprises a recess.

34. The modular element of claim 25 further comprising a securing member.

35. The modular element of claim 34 wherein the securing member comprises a retaining ring.

36. The modular element of claim 25 wherein at least one separation unit further comprises an outlet spout extending axially from the body and comprises an outlet end in fluid communication with the outlet opening.

37. The modular element of claim 25 wherein the plurality of separation units forms a linear array.

38. The modular element of claim 25 wherein the plurality of separation units forms a two-dimensional array.

33. The modular element of claim 25 wherein at least two separation units are frangibly connected.

34. The modular element of claim 25 further comprising:
a second mating structure generally at the outlet end configured to mate with a complementary mating structure of a second stackable element.

35. The modular element of claim 34 wherein the second mating structure of at least one separation unit and the complementary mating structure of at least one stackable element form a reversible press-fit seal.

36. The modular element of claim 34 wherein the second mating structure of the separation unit or the mating structure of the stackable element comprises a protuberance and the mating structure of the other unit comprises a recess.

37. The modular element of claim 34 wherein the units form a linear array.

38. The modular element of claim 34 wherein the units form a two-dimensional array.

39. The modular element of claim 34 wherein at least two units are frangibly connected.
